(19) United States
(12) Patent Application Publication
(10) Pub. No.: US 2026/0302913 A1
(43) Pub. Date: Oct. 1, 2026

(54) DC POWER CONVERSION DEVICE AND CONTROL METHOD

(71) Applicant: TMEIC Corporation, Tokyo (JP)

(72) Inventor: Yuji OKADA, Tokyo (JP)

(21) Appl. No.: 19/489,432

(22) PCT Filed: Jun. 7, 2023
(86) PCT No.: PCT/JP2023/021159

§ 371 Date: Dec. 2, 2025

(51) Int. Cl. H02M 1/00; H02M 1/08; H02M 3/335

(52) U.S. Cl. CPC H02M 1/0022; H02M 1/081; H02M 3/33573; H02M 3/33592

(57) ABSTRACT

In a direct current (DC) power conversion device according to an embodiment, a first bridge circuit is driven by a first drive signal and converts first DC power of a first DC voltage into first alternating current (AC) power. A second bridge circuit is driven by a second drive signal and converts second DC power of a second DC voltage into second AC power. An inductance element is provided between the first bridge circuit and the second bridge circuit. A control device decides a phase difference between the first drive signal and the second drive signal using phase shift control based on a dual active bridge (DAB) scheme, generates each of the first drive signal and the second drive signal for driving the first bridge circuit and the second bridge circuit in accordance with the phase difference, and drives the first bridge circuit and the second bridge circuit using the first drive signal and the second drive signal. The control device determines an allowable range of the phase difference using the first DC voltage and the second DC voltage and generates the first drive signal and the second drive signal between which the phase difference is limited within the allowable range when a magnitude of an electric current flowing through the inductance element is limited.

### TECHNICAL FIELD

An embodiment of the present invention relates to a direct current (DC) power conversion device and a control method.

### BACKGROUND ART

A control scheme for a DC power conversion device is a dual active bridge (DAB) scheme. The DC power conversion device of the DAB scheme has a main circuit in which alternating current (AC) sides of a pair of full bridge circuits (DC/AC conversion circuits) are connected to each other via an inductance element such as a transformer.

In the power conversion control of the DAB scheme, a power transmission direction and a conversion amount can be controlled by adjusting a relationship between a phase of a drive signal for a full-bridge circuit on a primary side and a phase of a drive signal for a full-bridge circuit on a secondary side. When a voltage fluctuation occurs between an input voltage and an output voltage of the DC power conversion device, an electric current related to the power conversion may not flow as expected.

### CITATION LIST

### Patent Document

Patent Document 1: Republished Japanese Translation No. 2019/1676271 of the PCT International Publication for Patent Applications

### SUMMARY OF INVENTION

### Technical Problem

An objective of the present invention is to provide a DC power conversion device and a control method capable of reducing an influence of voltage fluctuations occurring between input and output voltages of a DC power conversion device of a DAB scheme.

### Solution to Problem

According to an embodiment, a DC power conversion device performs power conversion between first DC power and second DC power on the basis of power conversion control of a DAB scheme for transmitting electric power between the first DC power and the second DC power. The DC power conversion device includes a first bridge circuit, a second bridge circuit, an inductance element, and a control device. The first bridge circuit is driven by a first drive signal and converts the first DC power of a first DC voltage into first AC power and output the first AC power to a first AC terminal. The second bridge circuit is driven by a second drive signal and converts the second DC power of a second DC voltage into a second AC power and output the second AC power to a second AC terminal. The inductance element is provided between the first bridge circuit and the second bridge circuit and connected to each of the first AC terminal and the second AC terminal. The control device decides a phase difference between the first drive signal and the second drive signal using phase shift control based on the DAB scheme, generates each of the first drive signal and the second drive signal for driving the first bridge circuit and the second bridge circuit in accordance with the phase difference, and drives the first bridge circuit and the second bridge circuit using the first drive signal and the second drive signal. The control device determines an allowable range of the phase difference using the first DC voltage and the second DC voltage and generates the first drive signal and the second drive signal between which the phase difference is limited within the allowable range when a magnitude of an electric current flowing through the inductance element is limited.

### BRIEF DESCRIPTION OF DRAWINGS

FIG. 1 A configuration diagram of a power conversion device according to an embodiment.

FIG. 2 A diagram showing an equivalent circuit of an inductance element.

FIG. 3 An explanatory diagram of an operation of a DC/DC converter.

FIG. 4A A block diagram of a control device for the power conversion device according to the embodiment.

FIG. 4B An explanatory diagram of an arithmetic expression used by the control device according to the embodiment.

FIG. 5 An explanatory diagram of an electric current waveform generated in a control process according to the embodiment.

FIG. 6 An explanatory diagram of an example of the electric current waveform.

### DESCRIPTION OF EMBODIMENTS

Hereinafter, a DC power conversion device and a control method according to an embodiment will be described with reference to the drawings. In addition, in the following description, constituent elements having the same or similar functions are denoted by the same reference signs. Also, redundant descriptions of these constituent elements may be omitted. In addition, an electrical connection may simply be referred to as a “connection.” In the following description, a case where “magnitudes are equal” includes a case where “magnitudes are approximately equal.”

### Embodiment

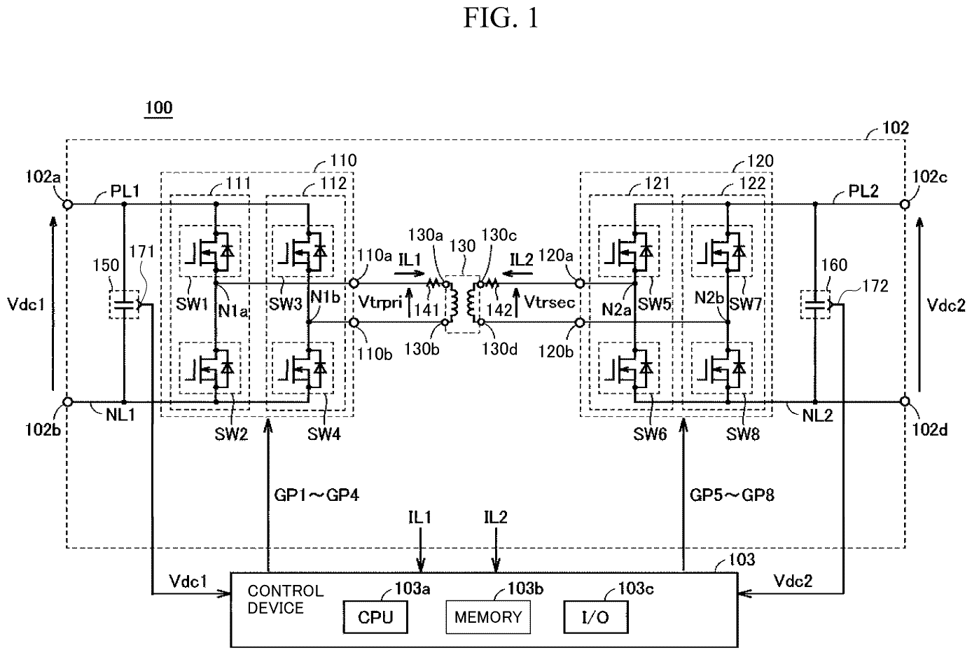

FIG. 1 is a configuration diagram of a DC power conversion device 100 according to an embodiment.

The DC power conversion device 100 includes a DC/DC converter 102 and a control device 103 forming a main circuit.

The DC power conversion device 100 further includes voltage detectors 171 and 172 and an electric current detector 141 for detecting an operating state of the main circuit.

The DC power conversion device 100 includes primary-side DC terminals 102a and 102b and secondary-side DC terminals 102c and 102d as terminals connected to an external bus and the like.

The DC/DC converter 102 performs power conversion (DC/DC conversion) between a primary-side DC voltage V_{dc1} across primary-side DC terminals 102a and 102b and a secondary-side DC voltage V_{dc2} across secondary-side DC terminals 102c and 102d.

The DC/DC converter 102 is a DC/DC converter having a DAB configuration. For example, the DC/DC converter 102 includes a primary-side bridge circuit 110, a secondary-side bridge circuit 120, an inductance element 130, and smoothing capacitors 150 and 160. The primary-side bridge circuit 110 and the secondary-side bridge circuit 120 are an example of a pair of bridge circuits.

The primary-side bridge circuit 110 constitutes a single-phase full bridge. Specifically, the primary-side bridge circuit 110 has semiconductor switching elements SW1 to SW4 connected between a high-potential-side power supply wiring PL1 and a low-potential-side power supply wiring NL1. The power supply wiring PL1 and the power supply wiring NL1 are connected to primary-side DC terminals 102a and 102b, respectively. A smoothing capacitor 150 for stabilizing a primary-side DC voltage V_{dc1} is connected between the power supply wiring PL1 and the power supply wiring NL1.

The semiconductor switching elements SW1 and SW2 are connected in series via a node N1a to form a first leg 111 connected between the power supply wiring PL1 and the power supply wiring NL1. The node N1a is connected to an AC terminal 123a. Likewise, the semiconductor switching elements SW3 and SW4 are connected between the power supply wiring PL1 and the power supply wiring NL1 via a node N1b to form a second leg 112. The node N1b is connected to an AC terminal 123b.

Likewise, the secondary-side bridge circuit 120 constitutes a single-phase full bridge. Specifically, the secondary-side bridge circuit 120 has semiconductor switching elements SW5 to SW8 connected between a high-potential-side power supply wiring PL2 and a low-potential-side power supply wiring NL2. The power supply wiring PL2 and the power supply wiring NL2 are connected to secondary-side DC terminals 102c and 102d, respectively. A smoothing capacitor 160 for stabilizing the secondary-side DC voltage V_{dc2} is connected between the power supply wiring PL2 and the power supply wiring NL2.

The semiconductor switching elements SW5 and SW6 are connected in series between the power supply wiring PL2 and the power supply wiring NL2 via a node N2a connected to an AC terminal 124a to form a third leg 121. Likewise, the semiconductor switching elements SW7 and SW8 are connected in series between the power supply wiring PL2 and the power supply wiring NL2 via a node N2b connected to the AC terminal 124b to form a fourth leg 122. In the first to fourth legs 111, 112, 121, and 122, the semiconductor switching elements SW1, SW3, SW5, and SW7 form an “upper arm” and the semiconductor switching elements SW2, SW4, SW6, and SW8 form a “lower arm.” Hereinafter, the semiconductor switching elements SW1 to SW8 are collectively referred to as semiconductor switching elements SW.

The semiconductor switching element SW includes a self-turn-off type switching element and a diode. The switching element can include any self-turn-off type element such as an insulated gate bipolar transistor (IGBT), a metal oxide semiconductor field effect transistor (MOSFET), or a gate commuted turn-off (GCT). The diode is connected in inverse parallel to the switching element and includes a freewheeling diode (FWD).

The inductance element 130 has primary-side AC terminals 130a and 130b respectively connected to the AC terminals 123a and 123b of the primary-side bridge circuit 110 and secondary-side AC terminals 130c and 130d respectively connected to the AC terminals 124a and 124b of the secondary-side bridge circuit 120. In the example of FIG. 1, the inductance element 130 includes a transformer 11 having a primary winding 11a connected between the primary-side AC terminals 130a and 130b, and a secondary winding 11b connected between the secondary-side AC terminals 130c and 130d.

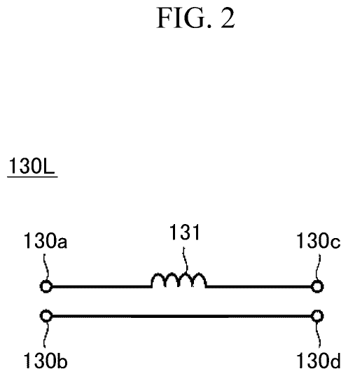

FIG. 2 is a diagram showing an equivalent circuit of the inductance element 130. As shown in FIG. 2, an inductance element 130L can also be configured to include a reactor 11c connected between the primary-side AC terminal 130a and the secondary-side AC terminal 130c. The inductance element 130L shown in FIG. 2 can be used as an equivalent circuit of the inductance element 130 described above. Although the inductance element 130L is an unbalanced circuit provided in one of the circuits in FIG. 2, it may be a balanced circuit provided in both circuits.

Returning to FIG. 1, the voltage detector 171 detects the voltage across the terminals of the smoothing capacitor 150, i.e., the primary-side DC voltage V_{dc1}, and outputs a signal indicating a detection value to the control device 103. The voltage detector 172 detects the voltage across the terminals of the smoothing capacitor 160, i.e., the secondary-side DC voltage V_{dc2}, and outputs a signal indicating the detection value to the control device 103.

The electric current detector 141 detects an AC current I_{L1} (hereinafter also referred to as a “primary-side AC current”) flowing between the AC terminal 123a of the primary-side bridge circuit 110 and the primary-side AC terminal 130a of the inductance element 130 and outputs a signal indicating the detection value to the control device 103.

The electric current detector 142 detects an AC current I_{L2} (hereinafter also referred to as a “secondary-side AC current”) flowing between the AC terminal 124a of the secondary-side bridge circuit 120 and the secondary-side AC terminal 130c of the inductance element 130 and outputs a signal indicating the detection value to the control device 103.

In the following description, a direction of the primary-side AC current I_{L1} flowing from the primary-side bridge circuit 110 to the inductance element 130 is referred to as a positive direction. Also, a direction of the secondary-side AC current I_{L2} flowing from the secondary-side bridge circuit 120 to the inductance element 130 is referred to as a positive direction.

In addition, the electric current detector may be either one of the electric current detector 141 and the electric current detector 142. For example, the electric current detector 141 may be provided on the primary side.

The control device 103 controls the power conversion in the DC/DC converter 102. Specifically, the control device 103 generates control signals (gate signals) GP1 to GP8 for controlling ON/OFF of the semiconductor switching elements SW1 to SW8 on the basis of commands from a higher-level controller (not shown) and output signals from the voltage detectors 171 and 172 and the electric current detector 141.

For example, the control device 103 can include a microprocessor including a central processing unit (CPU) 103a, a memory 103b, and an input/output (I/O) circuit 103c. The input/output circuit 103a receives detection values from sensors arranged in the DC/DC converter 102 and outputs control signals to the constituent elements of the DC/DC converter 102. The control signals include the above-mentioned gate signals GP1 to GP8.

The control device 103 can implement a control function to be described below according to a software process in which the CPU 103a executes an arithmetic process according to a program stored in the memory 103b. Alternatively, the control device 103 can implement some or all control functions according to a hardware process using a dedicated electronic circuit.

The DC/DC converter 102 converts DC power input from the primary-side DC terminal 102a into AC power (single-phase AC power in the example of FIG. 1) using the primary-side bridge circuit 110. The AC power is transmitted to the secondary-side bridge circuit 120 via the inductance element 130. The secondary-side bridge circuit 120 converts the AC power into DC power again and transmits the DC power to the secondary-side DC terminals 102c and 102d. In this case, electric power is transmitted from the primary-side DC terminals 102a and 102b to the secondary-side DC terminals 102c and 102d.

Alternatively, the DC/DC converter 102 can transmit electric power from the secondary-side DC terminals 102c and 102d to the primary-side DC terminals 102a and 102b according to the symmetry of the circuit. In this case, the DC power input to the secondary-side DC terminal 102c is converted into AC power (single-phase AC power in the example of FIG. 1) by the secondary-side bridge circuit 120, and the AC power is transmitted to the primary-side bridge circuit 110 via the inductance element 130. The primary-side bridge circuit 110 converts the AC power to DC power again and transmits the DC power to the primary-side DC terminals 102a and 102b. Thus, the DC power conversion device 100 can perform DC voltage conversion between the primary side and the secondary side, and either power transmission from the primary side to the secondary side or power transmission from the secondary side to the primary side can be controlled in the power transmission direction.

Next, an operation of the DC power conversion device 100 according to the embodiment will be described.

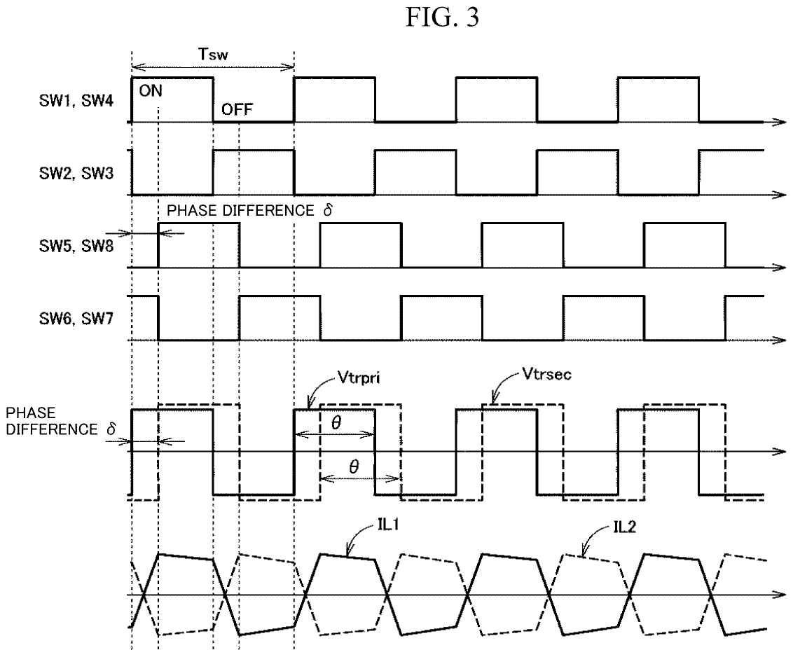

FIG. 3 is an explanatory diagram for the operation of the DC/DC converter 102. In FIG. 3, the operation when the transformer 11 is applied as the inductance element 130 is shown. The horizontal axis of FIG. 3 represents a switching phase in which a switching period T_{sw} of each semiconductor switching element SW is one period (2π).

As shown in FIG. 3, in the primary-side bridge circuit 110, the semiconductor switching elements SW1 and SW2 included in the same leg are turned on and off in a complementary manner. Likewise, the semiconductor switching elements SW3 and SW4 are also turned on and off in a complementary manner. Furthermore, the semiconductor switching elements SW1 and SW4 are turned on and off in the same phase, and the semiconductor switching elements SW2 and SW3 are turned on and off in the same phase. The semiconductor switching elements SW1 to SW4 are periodically turned on and off according to a state of a drive signal (a gate pulse GP). Although the above is a case where Duty (a duty factor) of the drive signal is (π/2), the present invention is not limited thereto and any desired Duty may be used.

Likewise, in the secondary-side bridge circuit 120, the semiconductor switching elements SW5 and SW6 included in the same leg are turned on and off in a complementary manner. Likewise, the semiconductor switching elements SW7 and SW8 are turned on and off in a complementary manner. Furthermore, the semiconductor switching elements SW5 and SW8 are turned on and off in the same phase and the semiconductor switching elements SW6 and SW7 are turned on and off in the same phase. The semiconductor switching elements SW5 to SW8 are switched on and off periodically every (π/2) of the switching period T_{sw} according to a state of a drive signal (a gate pulse GP).

A phase difference δ is provided between a timing at which the semiconductor switching elements SW1 to SW4 in the primary-side bridge circuit 110 are switched on and off and a timing at which the semiconductor switching elements SW5 to SW8 in the secondary-side bridge circuit 120 are switched on and off (0≤δ≤π).

According to such ON/OFF control of the semiconductor switching elements SW1 to SW8 in the primary-side bridge circuit 110 and the secondary-side bridge circuit 120, an AC voltage Vₜᵣₚᵣᵢ (hereinafter also referred to as a “primary-side AC voltage”) is generated between the primary-side AC terminals 130a and 130b of the inductance element 130 (both ends of the primary winding 11a) and an AC voltage V_{trsec} (hereinafter also referred to as a “secondary-side AC voltage”) is generated between the secondary-side AC terminals 130c and 130d of the inductance element 130 (both ends of the secondary winding 11b).

Moreover, the electric current flowing through the secondary winding 11b is referred to as a secondary-side AC current I_{L2} and the electric current flowing through the primary winding 11a is referred to as the primary-side AC current I_{L1}. When the turns ratio of the transformer is 1, the primary-side AC current I_{L1} and the secondary-side AC current I_{L2} are equal in magnitude and flow in opposite directions. This relationship is expressed by the following equation.

$${I}_{L 1} = - {I}_{L 2}$$

In addition, the primary-side AC current I_{L1} and the secondary-side AC current I_{L2} are collectively referred to as reactor currents I_{L}.

Each of the primary-side AC voltage Vₜᵣₚᵣᵢ and the secondary-side AC voltage V_{trsec} is a square wave voltage having a voltage pulse width θ according to an ON period length of the semiconductor switching elements SW1 to SW8 (0≤θ≤π). Herein, a ratio of the ON period length of the semiconductor switching element SW to the switching period T_{sw} is defined as Duty.

Next, a power conversion control process of the control device 103 will be described.

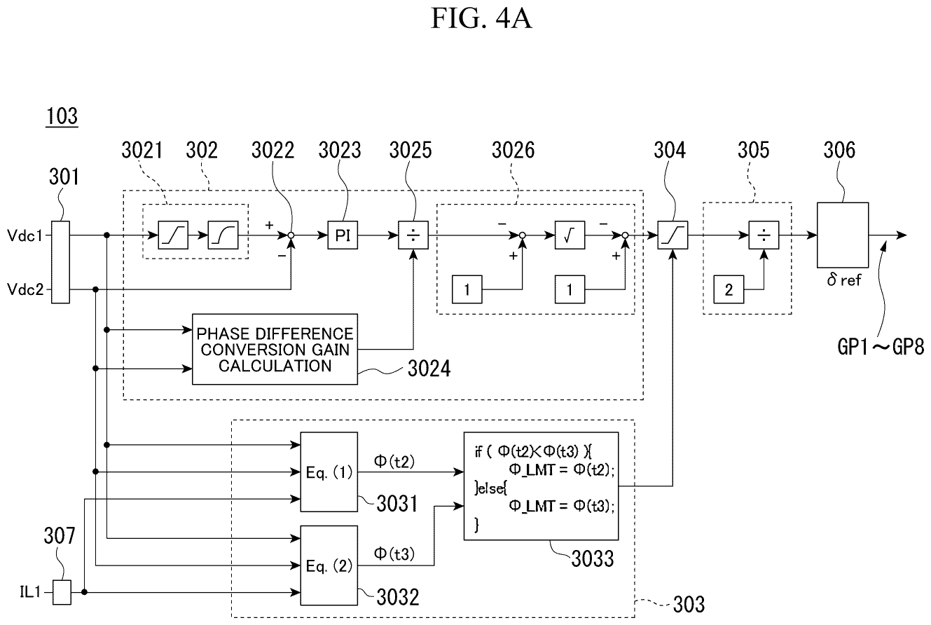

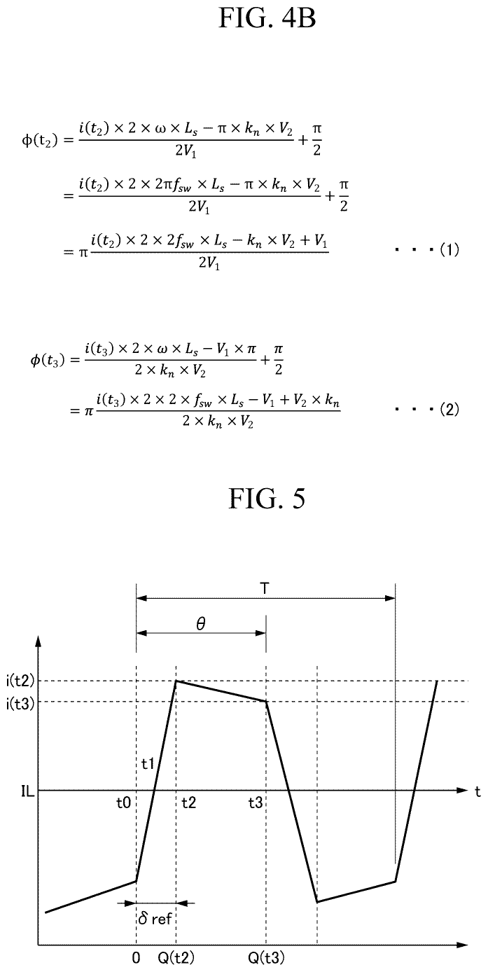

FIG. 4A is a block diagram of the control device 103 of the DC power conversion device 100 according to the embodiment. FIG. 4B is an explanatory diagram of an arithmetic expression used by the control device 103 according to the embodiment. FIG. 5 is an explanatory diagram of an electric current waveform generated by the control according to the embodiment.

It is assumed that the functions of blocks in respective block diagrams including FIG. 4A to be described below are implemented by at least one of a software process and a hardware process according to the control device 103.

The control device 103 includes, for example, a voltage detection unit 301, a phase difference generation unit 302, a limit value adjustment unit 303, a limiter 304, a phase difference command generation unit 305, an electric current control unit 306, and an electric current detection unit 307.

The voltage detection unit 301 receives output signals from the voltage detectors 171 and 172 (FIG. 1). The voltage detection unit 301 samples a detection value of the primary-side DC voltage V_{dc1} by the voltage detector 171 at a predetermined sampling period Tₛₐ and outputs a primary-side DC voltage detection value V_{dc1_det} based on the sampled value. The voltage detection unit 301 samples a detection value of the secondary-side DC voltage V_{dc2} using the voltage detector 172 at a sampling period Tₛₐ and outputs a secondary-side DC voltage detection value V_{dc2_det} based on the sampled value.

The phase difference generation unit 302 includes, for example, a voltage reference generation unit 3021, a subtractor 3022, a voltage control unit 3023, a phase difference conversion gain calculation unit 3024, a gain adjustment unit 3025, and a phase calculation unit 3026.

The voltage reference generation unit 3021 receives the primary-side DC voltage detection value V_{dc1_det} from the voltage detection unit 301 and generates a voltage reference based on the primary-side DC voltage detection value V_{dc1_det}. For example, the voltage reference generation unit 3021 performs a smoothing process on the primary-side DC voltage detection value V_{dc1_det} and outputs a primary-side DC voltage reference V_{dc1_ref} of its result.

The subtractor 3022 calculates a difference between the primary-side DC voltage reference V_{dc1_ref} provided by the voltage reference generation unit 3021 and the secondary-side DC voltage detection value V_{dc2_det} provided by the voltage detection unit 301 as a voltage command.

The voltage control unit 3023 generates a power command Pref by performing a PI calculation process with respect to an output (a voltage command) of the subtractor 3022. For example, the voltage control unit 3023 generates the power command Pref on the basis of a difference between the primary-side DC voltage reference V_{dc1_ref} provided by the voltage reference generation unit 3021 and the secondary-side DC voltage detection value V_{dc2_det} provided by the voltage detection unit 301 such that the difference becomes 0. This power command P_{ref} corresponds to the transmission power between the primary side and the secondary side.

The phase difference conversion gain calculation unit 3024 calculates a phase difference conversion gain based on the primary-side DC voltage reference V_{dc1_ref} and the secondary-side DC voltage detection value V_{dc2_det}.

The gain adjustment unit 3025 uses the phase difference conversion gain to normalize the power command generated by the voltage control unit 3023 for the phase difference conversion gain. More specifically, the gain adjustment unit 3025 outputs a result (quotient) of dividing the power command by the phase difference conversion gain as a phase adjustment amount.

The phase calculation unit 3026 adjusts the reference phase using the phase adjustment amount generated by the gain adjustment unit 3025. For example, the phase calculation unit 3026 subtracts the phase adjustment amount from a reference value (e.g., “1”) and calculates the square root of its result as a first reference phase. Furthermore, the phase calculation unit 3026 subtracts the first reference phase from the reference value (e.g., “1”) and calculates a second reference phase from its result.

Thereby, the phase difference generation unit 302 outputs the above-described second reference phase as a calculation result.

In addition, the phase difference generation unit 302 generates a command value for generating a phase difference between the primary-side AC voltage Vₜᵣₚᵣᵢ and the secondary-side AC voltage V_{trsec}. Because the AC currents I_{L1} and I_{L2} change according to this phase difference δ, the power transmitted between the primary side and the secondary side also changes. Therefore, by providing the phase difference δ set according to a power command value, the transmission power between the primary side and the secondary side can be controlled in accordance with the power command value.

Meanwhile, the transmission power P converted by the DC/DC converter 102 is expressed by the following Eq. (A) using the switching frequency f_{sw} of the semiconductor switching element SW, the inductance component L of the transformer 11, and the phase difference δ.

$$P = {V}_{d c 1} \cdot {V}_{d c 2} / ( 2 π \times {f}_{s w} \times L ) \cdot δ \cdot ( π - δ ) \qquad ( A )$$

When the above Eq. (1) is solved for the phase difference δ, it is deformed into the following Eq. (B).

$$δ = ( π / 2 ) \pm ( π / 2 ) \cdot √ ( 1 - ( 8 L \cdot {f}_{s w} \cdot P ) / ( {V}_{d c 1} \cdot {V}_{d c 2} ) ) \qquad ( B )$$

For example, if the phase difference δ is less than or equal to (π/2), a phase difference command value δ_{ref}, which is a command value for the phase difference δ, can be calculated from the power command value P_{ref} in accordance with the following Eq. (C).

$${δ}_{ref} ( π / 2 ) - ( π / 2 ) \cdot √ ( 1 - ( 8 L \cdot {f}_{s w} \cdot {P}_{ref} ) / ( {V}_{d c 1} \cdot {V}_{d c 2} ) ) \qquad ( C )$$

Therefore, it is only necessary to configure the limit value adjustment unit 303, the limiter 304, the phase difference command generation unit 305, the electric current control unit 306, and the electric current detection unit 307 as follows.

The electric current detection unit 307 receives, for example, an output signal of the electric current detector 141 (FIG. 1). The electric current detection unit 307 samples the output signal of the electric current detector 141 at a sampling period Tₛₐ, and outputs an electric current detection value I_{L1_det} based on the sampled value.

The limit value adjustment unit 303 receives the primary-side DC voltage reference V_{dc1_ref}, the secondary-side DC voltage detection value V_{dc2_det}, and the electric current detection value I_{L1_det}, and generates a limit value φ_LMT.

The limit value adjustment unit 303 includes, for example, limit value calculation units 3031 and 3032 and a limit value decision unit 3033.

The limit value calculation unit 3031 calculates the first limit value φ(t₂) on the basis of Eq. (1) shown in FIG. 4B.

The limit value calculation unit 3032 calculates the second limit value φ(t₃) on the basis of Eq. (2) shown in FIG. 4B.

Details of Eqs. (1) and (2) will be described below.

The limit value decision unit 3033 decides the limit value φ_LMT on the basis of magnitudes of the first limit value φ(t₂) and the second limit value φ(t₃). For example, the limit value decision unit 3033 selects the smaller one of the first limit value φ(t₂) and the second limit value φ(t₃).

When the second reference phase generated by the phase difference generation unit 302 is excessively greater than the limit value φ_LMT, the limiter 304 limits the magnitude of the second reference phase so that it becomes less than or equal to the limit value φ_LMT.

The phase difference command generation unit 305 divides the output value from the limiter 304 by two to calculate a phase difference command value δ_{ref} (a phase shift command δ_{ref}).

The electric current control unit 306 performs phase shift control by the DAB scheme using the phase difference command value δ_{ref}, provides a phase difference according to the phase shift command δ_{ref}, and generates gate pulses GP1 to GP8 for driving the DC/DC converter 102, and supplies the gate pulses GP1 to GP8 to the primary-side bridge circuit 110 and the secondary-side bridge circuit 120.

Thereby, the DC/DC converter 102 operates the primary-side bridge circuit 110 and the secondary-side bridge circuit 120 using the gate pulses GP1 to GP8.

When the control in the DC/DC converter 102 is in a steady state, the reactor current waveform is a repetition of a similar waveform as shown in FIG. 3. FIG. 5 shows one cycle of the waveform.

The parameters characterizing the reactor current waveform shown in FIG. 5 are defined as follows.

In addition, the primary-side DC voltage detection value V_{dc1_det} and the secondary-side DC voltage detection value V_{dc2_det} are treated as voltages applied to the primary- and secondary-side windings of the transformer. These are simply denoted by V₁ and V₂.

A secondary-side voltage V₂ of the transformer is converted into a primary-side voltage V₁ using a coefficient kₙ based on the turns ratio and this is denoted by V₂′.

V₂′=kₙV₂ (where kₙ=n₁/n₂ and n₁ and n₂ are the number of turns on the primary side and the number of turns on the secondary side.)

t₀, t₁, t₂, and t₃ on the horizontal axis in FIG. 5 indicate timings at which the control modes are started. The control mode is started at each of these timings. The order of the control modes is Mode 1-1, Mode 1-2, Mode 2, and Mode 3.
t₀: Start time of Mode 1-1
t₁: Start time of Mode 1-2
t₂: Start time of Mode 2
t₃: Start time of Mode 3

Although there is actually the time (the control mode) for charging and discharging a capacitor (not shown) when the switching operation is performed between the above control modes, the description thereof will be omitted for the sake of simplicity.

The magnitudes of the reactor currents at times t₀, t₁, t₂, and t₃ are denoted by i(t₀), i(t₁), i(t₂), and i(t₃), respectively.
i(t₀): Electric current of reactor at time t₀
i(t₁): Electric current of reactor at time t₁
i(t₂): Electric current of reactor at time t₂
i(t₃): Electric current of reactor at time t₃

The period is denoted by T, and the durations of the control modes are denoted by T₁ and T₂.
T: Period
T₁: Duration of Mode 1 (a combination range of Mode 1-1 and Mode 1-2)
T₂: Duration of Mode 2

An angle corresponding to the duration T₁ of Mode 1 is denoted by δ. An angle corresponding to the duration T₂ of Mode 2 is (2Dπ−δ). In addition, (2Dπ) is an angle corresponding to the pulse width of gate pulses GP1 to GP8 whose Duty (a duty factor) is D.
δ: Angle [rad] equivalent to duration T₁ of Mode 1 when the angle of one period is 2π [rad] (equivalent to a phase difference)
(2Dπ−δ): Angle [rad] corresponding to duration T₂ of Mode 2
D: Duty factor
ΔI_{L1}: Variation in electric current of reactor during Mode 1
ΔI_{L2}: Variation in electric current of reactor during Mode 2

$$i ( {t}_{0} ) = - i ( {t}_{3} )$$

$$i ( {t}_{1} ) = 0$$

$$i ( {t}_{2} ) = i ( {t}_{3} ) - Δ {I}_{L 2}$$

$$i ( {t}_{3} ) = ( Δ {I}_{L 1} + Δ {I}_{L 2} ) / 2$$

During Mode 1, (V₁+V₂′) is applied to the equivalent reactor. This relationship is shown in the following equation.

$$Δ {I}_{L 1} = ( {V}_{1} + {V}_{2}^{′} ) {T}_{1} / L$$

During Mode 2, (V₁−V₂′) is applied to the equivalent reactor. This relationship is shown in the following equation.

$$Δ {I}_{L 2} = ( {V}_{1} - {V}_{2}^{′} ) {T}_{2} / L$$

ΔI_{L2} can be a positive or negative value according to the magnitudes of V₁ and V₂′. For example, if V₂′ is greater than V₁, the value of ΔI_{L2} becomes the negative value, and electric power is sent from the secondary side to the primary side. The electric current waveform in this state is as shown in FIG. 5. On the other hand, if V₂′ is less than V₁, the value of ΔI_{L2} becomes positive, and electric power is sent from the primary side to the secondary side. The electric current waveform in this state is different from the waveform shown in FIG. 5, and the electric current increases during the period of Mode 2 from time t₂ to time t₃.

The following equation is obtained by adding the left sides of the two equations for ΔI_{L1} and ΔI_{L2} described above and adding the right sides thereof:

$$Δ {I}_{L 1} + Δ {I}_{L 2} = ( {V}_{1} + {V}_{2}^{′} ) {T}_{1} / L + ( {V}_{1} - {V}_{2}^{′} ) {T}_{2} / L = ( ( {T}_{1} + {T}_{2} ) {V}_{1} + ( {T}_{1} - {T}_{2} ) {V}_{2}^{′} ) / L$$

The following equation is valid with respect to T₁ and T₂.

$${T}_{1} = ( δ / 2 π ) T = δ / ω$$

$${T}_{2} = ( ( 2 D π - δ ) / 2 π ) T = ( 2 D π - δ ) / ω$$

When T₁ and T₂ are substituted into the above equation, it is rearranged to obtain the following equation.

$$Δ {I}_{L 1} + Δ {I}_{L 2} = ( 2 D π {V}_{1} + ( 2 δ - 2 D π ) {V}_{2}^{′} ) / ( ω L ) = 2 ( D π {V}_{1} + ( δ - D π ) {V}_{2}^{′} ) / ( ω L )$$

Therefore, i(t₂) and i(t₃) can be rearranged as follows.

$$i ( {t}_{2} ) = i ( {t}_{3} ) - Δ {I}_{L 2} = ( ( 2 δ - π ) {V}_{1} + π {V}_{2}^{′} ) / ( 2 ω L )$$

$$i ( {t}_{3} ) = ( Δ {I}_{L 1} + Δ {I}_{L 2} ) / 2 = ( D π V 1 + ( 2 δ - D π ) {V}_{2}^{′} ) / ( 2 ω L )$$

In a period of Mode 1 in FIG. 5, the following relationship exists. This is due to the similarity of triangles.

$$( {t}_{1} - {t}_{0} ) : ( {t}_{2} - {t}_{1} ) = - i ( {t}_{0} ) : i ( {t}_{2} ) = i ( {t}_{3} ) : i ( {t}_{2} )$$

$${t}_{1} - {t}_{0} = {T}_{1} \times i ( {t}_{3} ) / ( i ( {t}_{2} ) + i ( {t}_{3} ) )$$

$${t}_{2} - {t}_{1} = {T}_{1} \times i ( {t}_{2} ) / ( i ( {t}_{2} ) + i ( {t}_{3} ) )$$

The above equations are simplified by setting to as the starting point of time and the starting point of a phase, and the main equations are listed below.

$${t}_{1} = {T}_{1} \times i ( {t}_{3} ) / ( i ( {t}_{2} ) + i ( {t}_{3} ) )$$

$${t}_{2} = {T}_{1}$$

$${t}_{3} = {T}_{1} + {T}_{2}$$

$${T}_{1} = δ / ω$$

$${T}_{2} = ( 2 D π - δ ) / ω$$

$$i ( {t}_{0} ) = - i ( {t}_{3} )$$

$$i ( {t}_{1} ) = 0$$

$$i ( {t}_{2} ) = ( ( 2 δ - π ) {V}_{1} + π {V}_{2}^{′} ) / ( 2 ω L )$$

$$i ( {t}_{3} ) = ( D π {V}_{1} + ( 2 δ - D π ) {V}_{2}^{′} ) / ( 2 ω L ) = ( D π {V}_{1} + ( 2 δ - D π ) ( {k}_{n} ) {V}_{2} ) / ( 2 ω L )$$

$${V}_{2}^{′} = ( {k}_{n} ) {V}_{2} ( where {k}_{n} = {n}_{1} / {n}_{2} )$$

$$ω = 2 π f$$

If the above value of D, i.e., Duty, is set to 0.5, the equation shown in FIG. 4B can be obtained.

In this way, in the control of the DAB scheme, a peak value of an electric current flowing through the winding of the transformer can be obtained on the basis of the primary-side DC voltage V_{dc1}, the secondary-side DC voltage V_{dc2}, the inductance of the transformer, the turns ratio of the transformer, and the phase difference δ.

As described above, the peak value of the electric current flowing through the winding of the transformer varies with the primary-side DC voltage V_{dc1}, the secondary-side DC voltage V_{dc2}, and the phase difference δ.

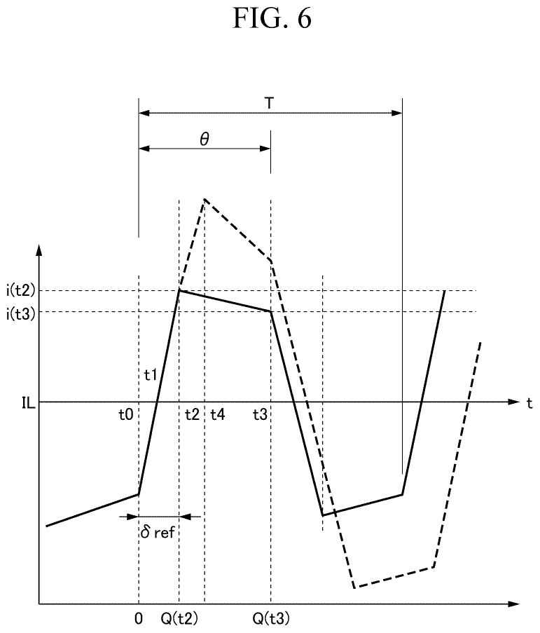

FIG. 6 is an explanatory diagram of an example of an electric current waveform.

For example, if a phase difference δ is set so that the electric current flowing through the winding of the transformer has an amplitude of a waveform as indicated by a dotted line in FIG. 6, a state in which Mode 2 continues until time t₄ corresponding to the phase difference δ occurs.

In the case of the comparative example, if a situation in which the electric current indicated by the dotted line in FIG. 6 flows occurs, an overcurrent flows through the winding of the transformer and each semiconductor switching element.

In the case of the present embodiment, because the phase difference δ is limited at time t₂ before the electric current indicated by the dotted line in FIG. 6 described above flows, the control in Mode 1 does not continue beyond the phase difference δ at time t₂, and the mode is switched from Mode 1 to Mode 2 at time t₂. As a result, the peak value of the electric current flowing through the winding of the transformer is limited to an electric current value equivalent to i(t₂) shown in FIG. 5.

From the above-described relationship, it becomes possible to indirectly set an upper limit for the electric current value by limiting the phase difference δ. An upper limit value of the phase difference command value δ_{ref} used for such control is calculated using information of the current primary-side DC voltage V_{dc1} and secondary-side DC voltage V_{dc2}. Thereby, it is possible to set a limit value based on the upper limit value of the electric current flowing through the winding of the transformer for the phase difference command value δ_{ref} in the phase shift control scheme.

By implementing such control, it becomes possible to set the limit value of the electric current flowing through the winding of the transformer to a value at which the device is not destroyed. Thereby, it is possible to prevent the device from being destroyed by the overcurrent in design. In addition to this, it is possible to improve the accuracy of estimating a magnitude of the maximum current that actually flows and further optimize derating against the overcurrent. As a result of such studies, by selecting a design policy that suppresses the maximum current, the range of selection for semiconductor switching elements can be expanded and DC power conversion devices can be miniaturized.

According to the above-described embodiment, the DC power conversion device 100 performs power conversion control of the DAB scheme for transferring electric power between the first DC power and the second DC power.

The primary-side bridge circuit 110 of the DC power conversion device 100 is driven by gate pulses GP1 to GP4 (a first drive signal) and converts first DC power of a first DC voltage into first AC power and outputs the first AC power to a first AC terminal. The secondary-side bridge circuit 120 is driven by gate pulses GP5 to GP8 (a second drive signal) and converts second DC power of a second DC voltage into second AC power and outputs the second AC power to a second AC terminal.

The inductance element 130 is provided between the primary-side bridge circuit 110 and the secondary-side bridge circuit 120 and is connected to each of the first AC terminal and the second AC terminal.

The control device 103 decides a phase difference between the first drive signal and the second drive signal for use in phase shift control using the DAB scheme, generates the first drive signal and the second drive signal that drive the primary-side bridge circuit 110 and the secondary-side bridge circuit 120 in accordance with the phase difference, and drives the primary-side bridge circuit 110 and the secondary-side bridge circuit 120 using the first drive signal and the second drive signal.

The control device 103 determines an allowable range of the phase difference using the first DC voltage and the second DC voltage and generates the first drive signal and the second drive signal with the phase difference limited within the allowable range when the magnitude of the electric current flowing through the inductance element 130 is limited.

Thereby, the DC power conversion device 100 can reduce the influence of voltage fluctuations occurring between the input voltage and output voltage of the DC power conversion device of the DAB scheme.

In addition, the control device 103 may decide the allowable range on the basis of the magnitude of the first DC voltage, the second DC voltage, and the electric current flowing through the inductance element 130.

The inductance element 130 may be configured to include a transformer.

For example, it is only necessary for the control device 103 to decide a limit value that limits the magnitude of the phase difference using the first DC voltage, the second DC voltage, the inductance of the inductance element 130 (the transformer), and the turns ratio of the transformer.

Alternatively, it is only necessary for the control device 103 to estimate the magnitude of the electric current flowing through the inductance element 130 using the first DC voltage, the second DC voltage, the inductance of the inductance element (the transformer), the turns ratio of the transformer, and the magnitude of the phase difference.

Moreover, for example, in the control device 103, the phase difference generation unit 302 outputs the above-described second reference phase as a calculation result. The limit value adjustment unit 303 calculates the first limit value φ(t₂) and the second limit value φ(t₃) and decides the limit value φ_LMT on the basis of the magnitudes of the first limit value φ(t₂) and the second limit value φ(t₃). The limiter 304 transmits the generated second reference phase when the generated second reference phase is not greater than the limit value φ_LMT, and limits the magnitude of the second reference phase so that the magnitude is less than or equal to the limit value φ_LMT when the generated second reference phase is greater than the limit value φ_LMT. For example, after the phase difference command generation unit generates a phase difference command value δ_{ref} from the output of the limiter 304, the electric current control unit 306 may use the phase difference command value δ_{ref} to perform phase shift control by the DAB scheme.

More specifically, the first limit value calculation unit 3031 of the limit value adjustment unit 303 calculates the first limit value φ(t₂) of the phase shift control. The first limit value calculation unit 3032 calculates the second limit value φ(t₃) of the above-described phase shift control. It is only necessary for the limit value decision unit 3033 to decide the limit value φ_LMT on the basis of the magnitudes of the first limit value φ(t₂) and the second limit value φ(t₃).

### Modified Example 1

Modified Example 1 of the embodiment will be described.

In the above-described embodiment, Duty of the drive signal (gate pulse) shown in FIG. 3 or the like is exemplified as 0.5. Alternatively, the same Duty may be set to a value other than 0.5. In this case, it is only necessary to use an equation including the Duty value (D) as an arithmetic equation for deciding the limit value of the phase difference command value δ_{ref}.

The value of Duty (D) may be a predetermined value (a constant) or may be a variable whose value is set according to the state of control. It is only necessary to use the most recent value of Duty (D) when the limit value of the phase difference command value δ_{ref} is decided.

### Modified Example 2

Modified Example 2 of the embodiment will be described.

In the above-described embodiment, the description of the excitation current of the transformer has been omitted and the description has been centered on the effect of the load current. In addition to this, the effect of the excitation current of the transformer can be added to the examination to increase the accuracy.

For example, when an electric current with a superimposed DC component flows through a transformer and bias magnetism occurs, an excessive current compared to the normal current may flow through the winding of the transformer. When this state occurs, a difference may occur between the AC current I_{L1} and the AC current I_{L2} even in a transformer with a turns ratio of 1.

Therefore, it is only necessary to detect the AC current I_{L1} and the AC current I_{L2} and decide the limit value of the phase difference command value δ_{ref} on the basis of the AC current I_{L1} and the AC current I_{L2}.

For example, it is only necessary to use a representative value of either the detection value of the AC current I_{L1} or the detection value of the AC current I_{L2} to calculate the limit value of the phase difference command value δ_{ref}. It is only necessary to use a larger value between the detection value of the AC current I_{L1} and the detection value of the AC current I_{L2} or an average value of these two values as the above-described representative value.

According to at least one embodiment described above, a DC power conversion device performs power conversion between first DC power and second DC power on the basis of a DAB scheme for transmitting electric power between the first DC power and the second DC power. The DC power conversion device includes a first bridge circuit, a second bridge circuit, an inductance element, and a control device. The first bridge circuit is driven by a first drive signal and converts the first DC power into first AC power and output the first AC power to a first AC terminal. The second bridge circuit is driven by a second drive signal and converts the second DC power of a second DC voltage into a second AC power and output the second AC power to a second AC terminal. The inductance element is provided between the first bridge circuit and the second bridge circuit and connected to each of the first AC terminal and the second AC terminal. The control device decides a phase difference between the first drive signal and the second drive signal using phase shift control based on the DAB scheme, generates each of the first drive signal and the second drive signal for driving the first bridge circuit and the second bridge circuit in accordance with the phase difference, and drives the first bridge circuit and the second bridge circuit using the first drive signal and the second drive signal. The control device determines an allowable range of the phase difference using the first DC voltage and the second DC voltage and generates the first drive signal and the second drive signal between which the phase difference is limited within the allowable range when a magnitude of an electric current flowing through the inductance element is limited, such that it is possible to reduce an influence of voltage fluctuations occurring between an input voltage and an output voltage of the DC power conversion device of the DAB scheme.

Some or all functional units of the control device 103 in the DC power conversion device 100 according to the embodiment described above, for example, may have a software functional unit that is implemented by a processor (a hardware processor) of the computer executing a program (a computer program or a software component) stored in a storage unit (a memory or the like) of a computer. In addition, some or all functional units of the control device 103 may be implemented by hardware such as a large-scale integration (LSI) circuit, an application-specific integrated circuit (ASIC), or a field-programmable gate array (FPGA), or may be implemented by a combination of the software functional unit and hardware.

While certain embodiments have been described, these embodiments have been presented by way of example only, and are not intended to limit the scope of the inventions. These embodiments can be implemented in various other forms, and various omissions, substitutions, and modifications can be made without departing from the spirit of the invention. For example, the configurations of the respective embodiments may be implemented in combination with each other, and can be applied to configurations whose descriptions are omitted. The accompanying claims and their equivalents are intended to cover such embodiments or modifications as would fall within the scope and spirit of the inventions.

### REFERENCE SIGNS LIST

100 DC power conversion device
102 DC/DC converter
103 Control device
110 Primary-side bridge circuit
120 Secondary-side bridge circuit
130 Inductance element
150, 160 Smoothing capacitor
301 Voltage detection unit
302 Phase difference generation unit
303 Limit value adjustment unit
304 Limiter
305 Phase difference command generation unit
306 Electric current control unit
307 Electric current detection unit
3031, 3032 Limit value calculation unit (first limit value calculation unit or second limit value calculation unit)
3033 Limit value decision unit

1. A direct current (DC) power conversion device based on power conversion control of a dual active bridge (DAB) scheme for transmitting electric power between first DC power and second DC power, the DC power conversion device comprising:
a first bridge circuit driven by a first drive signal and configured to convert the first DC power of a first DC voltage into first AC power and output the first AC power to a first AC terminal;
a second bridge circuit driven by a second drive signal and configured to convert the second DC power of a second DC voltage into second AC power and output the second AC power to a second AC terminal;
an inductance element provided between the first bridge circuit and the second bridge circuit and connected to each of the first AC terminal and the second AC terminal; and
a control device configured to decide a phase difference between the first drive signal and the second drive signal using phase shift control based on the DAB scheme, generate each of the first drive signal and the second drive signal for driving the first bridge circuit and the second bridge circuit in accordance with the phase difference, and drive the first bridge circuit and the second bridge circuit using the first drive signal and the second drive signal,
wherein the control device determines an allowable range of the phase difference using the first DC voltage and the second DC voltage and generates the first drive signal and the second drive signal between which the phase difference is limited within the allowable range when a magnitude of an electric current flowing through the inductance element is limited.

2. The DC power conversion device according to claim 1, wherein the control device decides the allowable range on the basis of magnitudes of the first DC voltage, the second DC voltage, and an electric current flowing through the inductance element.

3. The DC power conversion device according to claim 1,
wherein the inductance element is configured to include a transformer, and
wherein the control device decides a limit value for limiting a magnitude of the phase difference using the first DC voltage, the second DC voltage, the inductance of the inductance element, and a turns ratio of the transformer.

4. The DC power conversion device according to claim 1,
wherein the inductance element is configured to include a transformer, and
wherein the control device estimates a magnitude of an electric current flowing through the inductance element using the first DC voltage, the second DC voltage, the inductance of the inductance element, a turns ratio of the transformer, and a magnitude of the phase difference.

5. The DC power conversion device according to claim 1,
wherein the control device includes
a phase difference generation unit;
a limit value adjustment unit;
a limiter;
a phase difference command generation unit; and
an electric current control unit,
wherein the phase difference generation unit outputs a second reference phase as a calculation result,
wherein the limit value adjustment unit calculates a first limit value and a second limit value and decides a limit value on the basis of magnitudes of the first limit value and the second limit value,
wherein the limiter (304) transmits the second reference phase that has been generated when the generated second reference phase is not greater than the limit value and limits a magnitude of the second reference phase so that the generated second reference phase is less than or equal to the limit value when the generated second reference phase is greater than the limit value,
wherein the phase difference command generation unit generates a phase difference command value from an output of the limiter, and
wherein the electric current control unit performs phase shift control based on the DAB scheme using the phase difference command value.

6. The DC power conversion device according to claim 5,
wherein the limit value adjustment unit includes
a first limit value calculation unit;
a second limit value calculation unit; and
a limit value decision unit,
wherein the first limit value calculation unit calculates the first limit value of the phase shift control,
wherein the first limit value calculation unit calculates the second limit value of the phase shift control, and
wherein the limit value decision unit (3033) decides the limit value on the basis of magnitudes of the first limit value and the second limit value.

7. A control method for use in a DC power conversion device based on power conversion control of a DAB scheme for transmitting electric power between first DC power and second DC power, wherein the DC power conversion device includes a first bridge circuit driven by a first drive signal and configured to convert the first DC power of a first DC voltage into first AC power and output the first AC power to a first AC terminal, a second bridge circuit driven by a second drive signal and configured to convert the second DC power of a second DC voltage into second AC power and output the second AC power to a second AC terminal, and an inductance element provided between the first bridge circuit and the second bridge circuit and connected to each of the first AC terminal and the second AC terminal, the control method comprising:
deciding a phase difference between the first drive signal and the second drive signal using phase shift control based on the DAB scheme, generating each of the first drive signal and the second drive signal for driving the first bridge circuit and the second bridge circuit in accordance with the phase difference, and driving the first bridge circuit and the second bridge circuit using the first drive signal and the second drive signal; and
determining an allowable range of the phase difference using the first DC voltage and the second DC voltage and generating the first drive signal and the second drive signal between which the phase difference is limited within the allowable range when a magnitude of an electric current flowing through the inductance element is limited.

8. The control method according to claim 7, wherein the allowable range is decided on the basis of magnitudes of the first DC voltage, the second DC voltage, and an electric current flowing through the inductance element.

9. The control method according to claim 7,
wherein the inductance element is configured to include a transformer, and
wherein a limit value for limiting a magnitude of the phase difference is decided using the first DC voltage, the second DC voltage, the inductance of the inductance element, and a turns ratio of the transformer.

10. The control method according to claim 7,
wherein the inductance element is configured to include a transformer, and
wherein a magnitude of an electric current flowing through the inductance element is estimated using the first DC voltage, the second DC voltage, the inductance of the inductance element, a turns ratio of the transformer, and a magnitude of the phase difference.
